(19) United States
(12) Patent Application Publication
(10) Pub. No.: US 2026/0226264 A1
(43) Pub. Date: Aug. 6, 2026

(54) Propylene-Based Elastomer Compositions for Waterproof Applications Underground

(71) Applicant: ExxonMobil Technology and Engineering Company, Spring, TX (US)

(72) Inventor: Bo Chao LI, Shanghai (CN)

(21) Appl. No.: 19/148,993

(22) PCT Filed: Feb. 12, 2024
(86) PCT No.: PCT/IB2024/000086

§ 371 Date: Jul. 17, 2025

Related U.S. Application Data
(60) Provisional application No. 63/488,742, filed on Mar. 6, 2023.

(51) Int. Cl. C08L 23/14; C08K 5/134; C08K 5/372; C08K 5/524; E04D 5/06

(52) U.S. Cl. CPC C08L 23/142; C08K 5/134; C08K 5/372; C08K 5/524; C08L 2201/02; C08L 2205/025; C08L 2310/00; E04D 5/06

(57) ABSTRACT

This disclosure relates to a waterproof membrane that includes 40 wt % to 60 wt % of at least one propylene-based elastomer and 40 wt % to 60 wt % of at least one impact copolymer, based on the total weight of the blend composition. The at least one propylene-based elastomer is greater than 50 wt % propylene and from about 3 wt % to about 25 wt % units derived from ethylene and/or one or more C₄-C₁₂ α-olefins, based on a total weight of the propylene-based elastomer. The membrane has a thickness of 0.9 mm to 1.5 mm, a Tensile Force (N/50 mm) MD and TD of at least 600, as measured by GB/T328.9-2007, a Tensile Strength (MPa) MD and TD of at least 12, as measured by GB/T328.9-2007, an elongation @beak (%) MD and TD of at least 500 as measured by GB/T328.9-2007, a tear strength around nail (N) MD and TD of at least 400 as measured by GB/T 328.18, and a puncture strength (N) of at least 180 as measured by CJ/T 234-2006.

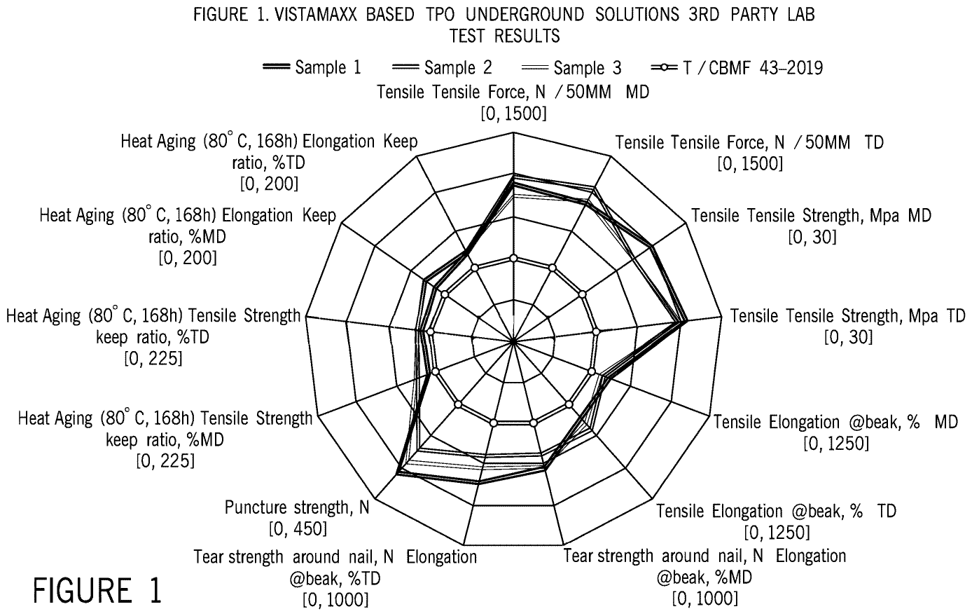

### CROSS-REFERENCE TO RELATED APPLICATION

This application claims the benefit of U.S. Provisional Application 63/488,742 filed Mar. 6, 2023 entitled, Propylene-Based Elastomer Compositions for Waterproof Applications Underground, the entirety of which is incorporated by reference herein.

### FIELD OF THE INVENTION

Embodiments of the present invention generally relate to propylene-based elastomer compositions. More particularly, embodiments of the present invention relate to propylene-based elastomer blends formulated for waterproof applications.

### BACKGROUND OF THE INVENTION

Waterproof materials are highly desirable for roofing and underground applications. Waterproofing materials prevent water intrusion into a surrounding structure. Waterproofing materials may also serve as a barrier to different pollutants. Waterproofing membranes are defined in most U.S. building codes as a preparation (coating/barrier) that is applied to the exterior surface of a roof, floors, foundation walls or in other areas that are known, or are expected, to be subject to hydrostatic pressures due to soil moistures conditions.

In the past, PVC was the preferred material for roofing and HDPE was preferred for underground applications. More recently, thermoplastic polyolefin (“TPO”) polymers have been used to replace PVC solutions for roofing applications and HDPE solutions for underground applications because of TPO's better flexibility, toughness and dimension stability.

TPO polymers are now used extensively in roofing applications for commercial buildings with flat roofs. Such roofing applications are typically a reflective roofing membrane made from blends of polypropylene and ethylene-propylene rubber and have a reflective white upper layer that is exposed to sunlight and a pigmented layer underneath the reflective layer that is attached to an insulation material. Underground sheeting or membranes are similarly constructed. Such underground applications are typically a membrane made from blends of polypropylene and ethylene-propylene rubber and have a pigmented layer underneath that is attached to an insulation material.

For roofing and underground sheeting applications, the products are typically manufactured as membrane sheets having a typical width of 10 feet (3 meters) or greater, although smaller widths can be available. The sheets are typically sold, transported, and stored in rolls. During transport and storage, the rolls can be exposed to extreme heat conditions, such as from 40° C. to 100° C., which can lead to roll blocking of the rolls during storage in warehouse. In use, these membranes should be able to withstand a wide variety of service temperatures, such as from −40° C. to +40° C. These membranes can also be exposed to a wide range of conditions that will deteriorate or destroy the integrity of the membrane over time.

Besides strength and temperature resistance, being waterproof is highly desirable for these membranes. There is a continuing need for TPO membranes having suitable strength and temperature resistance that are also waterproof at the requisite service temperatures.

### SUMMARY OF THE INVENTION

This disclosure relates to a waterproof propylene-based membrane. In at least one embodiment, the waterproof membrane includes 40 wt % to 60 wt % of at least one propylene-based elastomer and 40 wt % to 60 wt % of at least one impact copolymer, based on the total weight of the blend composition. The at least one propylene-based elastomer has a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tm) of 100° C. or less. The propylene-based elastomer is greater than 50 wt % propylene and from about 3 wt % to about 25 wt % units derived from ethylene and/or one or more C4-C12 α-olefins, based on a total weight of the propylene-based elastomer.

In at least one other embodiment, the waterproof membrane has 40 wt % to 60 wt % of at least one propylene-based elastomer, and 40 wt % to 60 wt % of at least one impact copolymer. The propylene-based elastomer has greater than 50 wt % propylene and from about 3 wt % to about wt % units derived from ethylene, based on a total weight of the propylene-based elastomer. The at least one impact copolymer is a propylene homopolymer blended with a propylene copolymer and has a total propylene-derived unit content of from about 88 to about 92 wt %, based on the weight of the ICP.

In at least one other embodiment, the waterproof membrane has 40 wt % to 60 wt % of at least one propylene-based elastomer, 40 wt % to 60 wt % of at least one impact copolymer, and 1 wt % to 5 wt % of a masterbatch comprising one or more anti-oxidants and one or more anti-agents, based on the total weight of the blend composition. The propylene-based elastomer has greater than 50 wt % propylene and from about 3 wt % to about 25 wt % units derived from ethylene and/or one or more C4-C12 α-olefins, based on a total weight of the propylene-based elastomer. The at least one impact copolymer is a propylene homopolymer blended with a propylene copolymer and has a total propylene-derived unit content of from about 88 to about 92 wt %, based on the weight of the ICP.

In any of the foregoing embodiments or elsewhere herein, the membrane has a thickness of 0.9 mm to 1.5 mm, a Tensile Force (N/50 mm) MD and TD of at least 600, as measured by GB/T328.9-2007, a Tensile Strength (MPa) MD and TD of at least 12, as measured by GB/T328.9-2007, an elongation @beak (%) MD and TD of at least 500 as measured by GB/T328.9-2007, a tear strength around nail (N) MD and TD of at least 400 as measured by GB/T 328.18, and a puncture strength (N) of at least 180 as measured by CJ/T 234-2006.

These and other features and attributes of the disclosed waterproof compositions of the present disclosure and their advantageous applications and/or uses will be apparent from the detailed description which follows.

### BRIEF DESCRIPTION OF DRAWINGS

To assist those of ordinary skill in the relevant art in making and using the subject matter hereof, reference is made to the one appended FIGURE that graphically depicts certain physical properties of three different waterproof blend compositions made according to one or more embodiments provided herein, in comparison to the minimum requirements of a waterproof composition as determined by the T/CBMF 43-2019 industry standard. The T/CBMF 43-2019 standard is the current standard industry preference for waterproof membranes in China.

### DETAILED DESCRIPTION

This disclosure relates to waterproof propylene-based elastomer (“PBE”) compositions that are suitable for all waterproof applications, including roofing and underground use. The waterproof propylene-based elastomer (“PBE”) composition is a blend that includes one or more PBEs and one or more impact copolymers (ICPs). Membranes made from the propylene-based elastomer (“PBE”) and ICP blend compositions described herein are waterproof at temperatures ranging from −40° C. to +40° C., which makes them highly desirable for roofing and underground applications. By “waterproof”, it is meant that the structure (e.g., membrane) made from the PBE blend composition described herein is impervious to water and water vapor for a significant amount of time, such as at least 20 years, 30 years, 50 years or 100 years.

As used herein, the term “elastomer” or “elastomer composition” refers to any polymer, co-polymer, or composition of polymers (such as blends of polymers) consistent with the ASTM D1566 definition. Elastomer includes mixed blends of polymers such as melt mixing and/or reactor blends of polymers.

As used herein, the term “copolymer” refers to polymers having two or more monomers, optionally, with other monomers, and can refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations can include isotactic, syndiotactic and atactic symmetries. The term “blend” as used herein refers to a mixture of two or more polymers.

The term “monomer” or “comonomer,” as used herein, refers to the monomer used to form the polymer, i.e., the unreacted chemical compound in the form prior to polymerization, and can also refer to the monomer after it has been incorporated into the polymer, also referred to herein as a “[monomer]-derived unit”. Different monomers are discussed herein, including propylene monomers, ethylene monomers, and diene monomers.

“Reactor grade,” as used herein, refers to a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

“Reactor blend,” as used herein, refers to a highly dispersed and mechanically inseparable blend of two or more polymers produced in situ as the result of sequential or parallel polymerization of one or more monomers with the formation of one polymer in the presence of another, or by solution blending polymers made separately in parallel reactors. Reactor blends can be produced in a single reactor, a series of reactors, or parallel reactors and are reactor grade blends. Reactor blends can be produced by any polymerization method, including batch, semi-continuous, or continuous systems. Particularly excluded from “reactor blend” polymers are blends of two or more polymers in which the polymers are blended ex situ, such as by physically or mechanically blending in a mixer, extruder, or other similar device.

The term “sequential polymerization” refers to a polymerization process wherein different polymers are produced at different periods of time in the same or different reactors, e.g., to produce a multimodal and/or heterophasic polymer.

As used herein, the terms “polypropylene,” “propylene polymer,” and “propylene-based polymer” refer to a polymer or copolymer comprising at least 50 mol % propylene units (preferably at least 70 mol % propylene units, more preferably at least 80 mol % propylene units, even more preferably at least 90 mol % propylene units, even more preferably at least 95 mol % propylene units or 100 mol % propylene units (in the case of a homopolymer)). An “ethylene polymer” or “polyethylene” or “ethylene copolymer” is a polymer or copolymer comprising at least 50 mol % ethylene derived units and so on.

The term “polypropylene” is meant to encompass isotactic polypropylene (iPP), defined as having at least 10% or more isotactic pentads, highly isotactic polypropylene, defined as having 50% or more isotactic pentads, syndiotactic polypropylene (sPP), defined as having at 10% or more syndiotactic pentads, homopolymer polypropylene (hPP, also called propylene homopolymer or homopolypropylene), and so-called random copolymer polypropylene (RCP, also called propylene random copolymer). Herein, an RCP is specifically defined to be a copolymer of propylene and 1 to 10 wt % of an olefin chosen from ethylene and C4 to C8 α-olefins. Preferably isotactic polymers (such as iPP) have at least 20% (preferably at least 30%, preferably at least 40%) isotactic pentads. A polyolefin is “atactic”, also referred to as “amorphous” if it has less than 10% isotactic pentads and syndiotactic pentads.

The terms “ethylene-propylene rubber” and “EP rubber” (EPR) refer to a copolymer of ethylene and propylene, and optionally one or more diene monomer(s), where the ethylene content is from 35 to 85 mol %, the total diene content is 0 to 5 mol %, and the balance is propylene with a minimum propylene content of 15 mol %.

The term “hetero-phase” or “heterophasic” refers to the presence of two or more morphological phases in a composition comprising two or more polymers, where each phase comprises a different polymer or a different ratio of the polymers as a result of partial or complete immiscibility (i.e., thermodynamic incompatibility). A common example is a morphology consisting of a continuous matrix phase and at least one dispersed or discontinuous phase. The dispersed phase takes the form of discrete domains (particles) distributed within the matrix (or within other phase domains, if there are more than two phases). Another example is a co-continuous morphology, where two phases are observed but it is unclear which one is the continuous phase, and which is the discontinuous phase, e.g., where a matrix phase has generally continuous internal pores and a fill phase is deposited within the pores, or where the fill phase expands within the pores of an initially globular matrix phase to expand the porous matrix globules, corresponding to the polymer initially formed on or in the support agglomerates, into subglobules which may be partially or wholly separated and/or co-continuous or dispersed within the fill phase, corresponding to the polymer formed on or in the primary particles of the support. For example, a polymer globule may initially have a matrix phase with a porosity corresponding to the support agglomerates, but a higher fill phase due to expansion of the fill phase in interstices between subglobules of the matrix phase.

The presence of multiple phases is determined using microscopy techniques, e.g., optical microscopy, scanning electron microscopy (SEM), or atomic force microscopy (AFM); or by the presence of two glass transition (Tg) peaks in a dynamic mechanical analysis (DMA) experiment; or by a physical method such as solvent extraction, e.g., xylene extraction at an elevated temperature to preferential separate one polymer phase; in the event of disagreement among these methods, DMA performed according to the procedure set out in US 2008/0045638 at page 36, including any references cited therein, shall be used.

A “polypropylene impact copolymer” or simply an “impact copolymer” (ICP) is a combination, typically heterophasic, of crystalline and amorphous polymers, such as, for example, iPP and rubber, which provide the ICP with both stiffness and toughness, i.e., a stiffness greater than that of one or more of the amorphous polymer(s) and a toughness greater than that of one or more of the crystalline polymer(s). An ICP may typically have a morphology such that the matrix phase comprises a higher proportion of the crystalline polymer, and a rubber is present in a higher proportion in a dispersed or co-continuous phase, e.g., a blend comprising 60 to 95 wt % of a matrix of iPP, and 5 to 40 wt % of an ethylene, propylene or other polymer with a Tg of 30° C. or less.

As used herein, “wt %” means weight percent, “mol %” means mole percent, “vol %” means volume percent, and all molecular weights, e.g., Mw, Mn, Mz, are in units of g/mol, unless otherwise noted. Furthermore, all molecular weights are Mw unless otherwise noted.

As used herein, when a polymer is said to comprise a certain percentage, wt %, of a monomer, that percentage of monomer is based on the total amount of monomer units in the polymer.

As used herein, “consisting essentially of” means that the described/claimed composition does not include any other components that will materially alter its properties by any more than 5% of that property, and in any case, does not include any other component to a level greater than 3 wt %.

As used herein, “substantially no,” and “substantially free of” are intended to mean that the subject item is not intentionally used or added in any amount but can be present in very small amounts existing as impurities resulting from environmental or process conditions.

Various specific embodiments, versions of the invention will now be described, including preferred embodiments and definitions that are adopted herein. While the following detailed description gives specific preferred embodiments, those skilled in the art will appreciate that these embodiments are exemplary only, and that the invention can be practiced in other ways.

### Propylene-Based Elastomer

The propylene-based elastomer is a random copolymer having crystalline regions interrupted by non-crystalline regions and within the range from 5 to 25 wt %, by weight of the propylene-based elastomer, of ethylene or C4 to C10 α-olefin derived units, and optionally diene-derived units, the remainder of the polymer being propylene-derived units. Not intended to be limited by any theory, it is believed that the non-crystalline regions can result from regions of non-crystallizable polypropylene segments and/or the inclusion of comonomer units. The crystallinity and the melting point of the propylene-based elastomer are reduced compared to highly isotactic polypropylene by the introduction of errors (stereo and region defects) in the insertion of propylene and/or by the presence of comonomer. The copolymer contains at least 50 wt % propylene-derived units by weight of the propylene-based elastomer. In any embodiment, the propylene-based elastomer is a propylene-based elastomer having limited crystallinity due to adjacent isotactic propylene units and a melting point as described herein. In other embodiments, the propylene-based elastomer is generally devoid of any substantial intermolecular heterogeneity in tacticity and comonomer composition, and also generally devoid of any substantial heterogeneity in intramolecular composition distribution.

The propylene-based elastomer contains greater than 50 wt %, preferably greater than 60 wt %, more preferably greater than 65 wt %, even more preferably greater than 75 wt % and up to 99 wt % propylene-derived units, based on the total weight of the propylene-based elastomer. In some preferable embodiments, the propylene-based elastomer includes propylene-derived units in an amount based on the weight of propylene-based elastomer of from 75 wt % to 95 wt %, more preferably 75 wt % to 92.5 wt %, and even more preferably 82.5 wt % to 92.5 wt %, and most preferably 82.5 wt % to 90 wt %. Correspondingly, the units, or comonomers, derived from at least one of ethylene or a C4 to C10 α-olefin can be present in an amount ranging from a low of 5, 10, or 14 wt % to a high of about 20, 22, or 25 wt % of the elastomer.

The comonomer content can be adjusted so that the propylene-based elastomer having a heat of fusion of 100 J/g, 90 J/g, 85 J/g, 80 J/g, 75 J/g, 70 J/g, or 65 J/g or less, a melting point (Tₘ) of 100° C. or 90° C. or less, and crystallinity of 2% to 65% of isotactic polypropylene, and preferably a melt flow rate (“MFR”), as measured at 230° C. and 2.16 kg weight, of less than 1,000 g/10 min.

The propylene-based elastomer can have more than one comonomer. Preferred embodiments of a propylene-based elastomer have more than one comonomer, such as propylene-ethylene-octene, propylene-ethylene-hexene, and propylene-ethylene-butene copolymers.

In embodiments where more than one comonomers derived from at least one of ethylene or a C4 to C10 α-olefins are present, the amount of each comonomer can be less than 25 wt % of the propylene-based elastomer, but the combined amount of comonomers by weight of the propylene-based elastomer is 3 wt % or greater. In preferred embodiments, the comonomer is ethylene, 1-hexene, or 1-octene, and preferably in an amount of 3, 5, 10, or 14 wt % to 15, 20, 22, or 25 wt %, based on the total weight of the propylene-based elastomer. The comonomer content of the propylene-based elastomer can also range from about 3 to about 35 wt %; about 3 to 15 wt %; or about 10 to 15 wt %, based on the total weight of the propylene-based elastomer.

In preferred embodiments, the propylene-based elastomer comprises ethylene-derived units. The propylene-based elastomer can comprise 3, 5, 10, or 14 wt % to 15, 20, 22, or 25 wt % of ethylene-derived units, based on the total weight of the propylene-based elastomer. The ethylene content of the propylene-based elastomer can also range from about 3 to about 35 wt %; about 3 to 15 wt %; about 10 to 15 wt %, or about 4 wt % to 8 wt %, based on the total weight of the propylene-based elastomer. In any embodiment, the propylene-based elastomer consists essentially of units derived from propylene and ethylene, i.e., the propylene-based elastomer does not contain any other comonomer in an amount typically present as impurities in the ethylene and/or propylene feed streams used during polymerization or an amount that would materially affect the heat of fusion, melting point, crystallinity, or melt flow rate of the propylene-based elastomer, or any other comonomer intentionally added to the polymerization process.

In certain embodiments, the propylene-based elastomer can also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene can be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. When used, the amount of diene comonomer can be equal to, or more than, 0.1 wt %, or 0.5 wt %, or 1 wt %, or 1.5 wt % and lower than, or equal to, 6 wt %, or 4 wt %, or 3 wt % or 2 wt %, based on the total weight of propylene-based elastomer.

The propylene-based elastomer has a heat of fusion (“Hf”), as determined by the Differential Scanning calorimetry (“DSC”), of 100 J/g or less, or 75 J/g or less, 70 J/g or less, 50 J/g or less, or 35 J/g or less. The propylene-based elastomer can have a lower limit Hf of 0.5 J/g, 1 J/g, or 5 J/g. For example, the Hf value can be anywhere from 1.0, 1.5, 3.0, 4.0, 6.0, or 7.0 J/g, to 30, 35, 40, 50, 60, 70, or 75 J/g.

The propylene-based elastomer can have a percent crystallinity, as determined according to the DSC procedure described herein, of 2% to 65%, preferably 0.5% to 40%, preferably 1% to 30%, and more preferably 5% to 35%, of isotactic polypropylene. The thermal energy for the highest order of propylene (i.e., 100% crystallinity) is estimated at 189 J/g. In any embodiment, the copolymer has a crystallinity in the range of 0.25% to 25%, or 0.5% to 22% of isotactic polypropylene.

The propylene-based elastomer can have a triad tacticity of three propylene units (mmm tacticity), as measured by 13C NMR, of 75% or greater, 80% or greater, 85% or greater, 90% or greater, 92% or greater, 95% or greater, or 97% or greater. For example, the triad tacticity can range from about 75 to about 99%, from about 80 to about 99%, from about 85 to about 99%, from about 90 to about 99%, from about 90 to about 97%, or from about 80 to about 97%. Triad tacticity can be determined by the methods described in U.S. Pat. No. 7,232,871.

The propylene-based elastomer can have a tacticity index m/r ranging from a lower limit of 4 or 6 to an upper limit of 8 or 10 or 12. The tacticity index, expressed herein as “m/r”, is determined by 13C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso, and “r” to racemic. An m/r ratio of 1.0 generally describes a syndiotactic polymer, and an m/r ratio of 2.0 describes an atactic material. The propylene-based elastomer can have a single peak melting transition as determined by DSC. In any embodiment, the copolymer has a primary peak transition of 90° C. or less, with a broad end-of-melt transition of 110° C. or greater. The peak “melting point” (“Tm”) is defined as the temperature of the greatest heat absorption within the range of melting of the sample. However, the copolymer can show secondary melting peaks adjacent to the principal peak, and/or at the end-of-melt transition. For the purposes of this disclosure, such secondary melting peaks are considered together as a single melting point, with the highest of these peaks being considered the Tm of the propylene-based elastomer. The propylene-based elastomer can have a Tm of 100° C. or less, 90° C. or less, 80° C. or less, or 70° C. or less. In any embodiment, the propylene-based elastomer can have a Tm of 25° C. to 100° C., 25° C. to 85° C., 25° C. to 75° C., or 25° C. to 65° C. In any embodiment, the propylene-based elastomer can have a Tm of 30° C. to 80° C. or 30° C. to 70° C.

To determine the thermal properties of the propylene-based elastomers provided herein, Differential Scanning calorimetry (“DSC”) is used. Such DSC data is obtained using a Perkin-Elmer DSC 7.5 mg to 10 mg of a sheet of the polymer to be tested is pressed at approximately 200° C. to 230° C., then removed with a punch die and annealed at room temperature for 48 hours. The samples are then sealed in aluminum sample pans. The DSC data is recorded by first cooling the sample to −50° C. and then gradually heating it to 200° C. at a rate of 10° C./minute. The sample is kept at 200° C. for 5 minutes before a second cooling-heating cycle was applied. Both the first and second cycle thermal events are recorded. Areas under the melting curves are measured and used to determine the heat of fusion and the degree of crystallinity.

The percent crystallinity (X %) is calculated using the formula, X %=[area under the curve (Joules/gram)/B (Joules/gram)]*100, where B is the heat of fusion for the homopolymer of the major monomer component. These values for B can be found from the Polymer Handbook, Fourth Edition, published by John Wiley and Sons, New York 1999. A value of 189 J/g (B) is used as the heat of fusion for 100% crystalline polypropylene. The melting temperature is measured and reported during the second heating cycle (or second melt).

In one or more embodiments, the propylene-based elastomer can have a Mooney viscosity [ML (1+4) @ 125° C.], as determined according to ASTM D-1646, of less than 100, in other embodiments less than 75, in other embodiments less than 60, and in other embodiments less than 30.

The propylene-based elastomer can have a density of 0.850 g/cm³ to 0.920 g/cm³, 0.860 g/cm³ to 0.900 g/cm³, or 0.860 g/cm³ to 0.890 g/cm³, at room temperature as measured per ASTM D-1505.

The propylene-based elastomer can have a melt flow rate (“MFR”) greater than 0.5 dg/min, and less than or equal to 1,000 dg/min, or less than or equal to 800 dg/min, less than or equal to 500 dg/min, less than or equal to 200 dg/min, less than or equal to 100 dg/min, or less than or equal to 50 dg/min. Some embodiments can include a propylene-based elastomer with an MFR of less than or equal to 25 dg/min, such as from 1 to 25 dg/min or 1 to 20 dg/min or 3 to 15 dg/min. The MFR also can range from a low of about 2.5, 3.5 or 4 g/10 min to a high of about 10, 15, 20, or 30 g/10 min. The MFR is determined according to ASTM D-1238, condition L (2.16 kg, 230° C.).

The propylene-based elastomer can have a weight average molecular weight (“Mw”) of 5,000 to 5,000,000 g/mole, 10,000 to 1,000,000 g/mole, or 50,000 to 400,000 g/mole; a number average molecular weight (“Mn”) of 2,500 to 2,500,00 g/mole, 10,000 to 250,000 g/mole, or 25,000 to 200,000 g/mole; and/or a z-average molecular weight (“Mz”) of 10,000 to 7,000,000 g/mole, 80,000 to 700,000 g/mole, or 100,000 to 500,000 g/mole. The propylene-based elastomer can have a molecular weight distribution (Mw/Mn, or “MWD”) of 1.5 to 20, or 1.5 to 15, 1.5 to 5, 1.8 to 5, or 1.8 to 4.

The propylene-based elastomer can have an Elongation at Break of less than 2000%, less than 1000%, or less than 800%, as measured per ASTM D412.

The propylene-based elastomer can be grafted (i.e., “functionalized”) using one or more grafting monomers. As used herein, the term “grafting” denotes covalent bonding of the grafting monomer to a polymer chain of the propylene-based elastomer. The grafting monomer can be or include at least one ethylenically unsaturated carboxylic acid or acid derivative, such as an acid anhydride, ester, salt, amide, imide, or acrylates. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2) octene-2,3-dicarboxylic acid anhydride, 1,2,3,4,5,8,9,10-octahydronaphthalene-2,3-dicarboxylic acid anhydride, 2-oxa-1,3-diketospiro(4.4) nonene, bicyclo(2.2.1) heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1) heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride can be used as a grafting monomer. In embodiments where the graft monomer is maleic anhydride, the maleic anhydride concentration in the grafted polymer can be to about 6 wt %, at least about 0.5 wt %, or at least about 1.5 wt % based on the total weight of the propylene-based elastomer.

In some embodiments, the propylene-based elastomer can be a reactor blended polymer as defined herein. That is, the propylene-based elastomer is a reactor blend of a first polymer component and a second polymer component. Thus, the comonomer content of the propylene-based elastomer can be adjusted by adjusting the comonomer content of the first polymer component, adjusting the comonomer content of second polymer component, and/or adjusting the ratio of the first polymer component to the second polymer component present in the propylene-based elastomer.

In embodiments where the propylene-based elastomer is a reactor blended polymer, the α-olefin content of the first polymer component (“R1”) can be greater than 5 wt % α-olefin, greater than 7 wt % α-olefin, greater than 10 wt % α-olefin, greater than 12 wt % α-olefin, greater than 15 wt % α-olefin, or greater than 17 wt % α-olefin, where the percentage by weight is based upon the total weight of the propylene-derived and α-olefin-derived units of the first polymer component. The α-olefin content of the first polymer component can be less than 30 wt % α-olefin, less than 27 wt % α-olefin, less than 25 wt % α-olefin, less than 22 wt % α-olefin, less than 20 wt % α-olefin, or less than 19 wt % α-olefin, where the percentage by weight is based upon the total weight of the propylene-derived and α-olefin-derived units of the first polymer component. In some embodiments, the α-olefin content of the first polymer component can range from 5 wt % to 30 wt % α-olefin, from 7 wt % to 27 wt % α-olefin, from 10 wt % to 25 wt % α-olefin, from 12 wt % to 22 wt % α-olefin, from 15 wt % to 20 wt % α-olefin, or from 17 wt % to 19 wt % α-olefin. The first polymer component can comprise propylene and ethylene, and in some embodiments the first polymer component can consist only of propylene and ethylene derived units.

In embodiments where the propylene-based elastomer is a reactor blended polymer, the α-olefin content of the second polymer component (“R2”) can be greater than 1.0 wt % α-olefin, greater than 1.5 wt % α-olefin, greater than 2.0 wt % α-olefin, greater than 2.5 wt % α-olefin, greater than 2.75 wt % α-olefin, or greater than 3.0 wt % α-olefin, where the percentage by weight is based upon the total weight of the propylene-derived and α-olefin-derived units of the second polymer component. The α-olefin content of the second polymer component can be less than 10 wt % α-olefin, less than 9 wt % α-olefin, less than 8 wt % α-olefin, less than 7 wt % α-olefin, less than 6 wt % α-olefin, or less than 5 wt % α-olefin, where the percentage by weight is based upon the total weight of the propylene-derived and α-olefin-derived units of the second polymer component. In some embodiments, the α-olefin content of the second polymer component can range from 1.0 wt % to 10 wt % α-olefin, or from 1.5 wt % to 9 wt % α-olefin, or from 2.0 wt % to 8 wt % α-olefin, or from 2.5 wt % to 7 wt % α-olefin, or from 2.75 wt % to 6 wt % α-olefin, or from 3 wt % to 5 wt % α-olefin. The second polymer component can comprise propylene and ethylene, and in some embodiments the first polymer component can consist only of propylene and ethylene derived units.

In embodiments where the propylene-based elastomer is a reactor blended polymer, the propylene-based elastomer can comprise from 1 to 25 wt % of the second polymer component, from 3 to 20 wt % of the second polymer component, from 5 to 18 wt % of the second polymer component, from 7 to 15 wt % of the second polymer component, or from 8 to 12 wt % of the second polymer component, based on the weight of the propylene-based elastomer. The propylene-based elastomer can comprise from 75 to 99 wt % of the first polymer component, from 80 to 97 wt % of the first polymer component, from 85 to 93 wt % of the first polymer component, or from 82 to 92 wt % of the first polymer component, based on the weight of the propylene-based elastomer.

The propylene-based elastomer can be prepared by any suitable means as known in the art. The propylene-based elastomer can be prepared using homogeneous conditions, such as a continuous solution polymerization process, using a metallocene catalyst. In some embodiments, the propylene-based elastomer can be prepared in parallel solution polymerization reactors, such that the first reactor component is prepared in a first reactor and the second reactor component is prepared in a second reactor, and the reactor effluent from the first and second reactors are combined and blended to form a single effluent from which the final propylene-based elastomer is separated. Exemplary methods for the preparation of propylene-based elastomers can be found in U.S. Pat. Nos. 6,881,800; 7,803,876; 8,013,069; and 8,026,323 and PCT Publications WO 2011/087729; WO 2011/087730; and WO 2011/087731.

Commercial examples of such propylene-based elastomers include Vistamaxx™ performance polymers from ExxonMobil Chemical Company, Tafmer™ elastomers from Mitsui Chemicals, and Versify™ elastomers from Dow Chemical Company.

### Impact Copolymer

The propylene-based elastomeric composition further includes one or more impact copolymers. Impact copolymers or ICPs consist of at least two distinct phases. There are any number of ways of making an ICP for use herein. Suitable ICPs, for example, can be made by physically blending polypropylene homopolymer component(s) and propylene-copolymer component(s); or are made in a single reactor process using dual catalysts to produce the different polymer components; or are produced in a series reactor process to produce individual components that are further combined in situ, or in one or more of the reactors.

For example, suitable ICPs can be produced in series reactors wherein the polypropylene homopolymer can be first produced in one or more slurry reactors by contacting a catalyst and monomers, preferably propylene, such as in slurry-loop reactors well known in the art, followed by combining the same catalyst and formed homopolymer in a single gas-phase reactor with monomers, preferably propylene and ethylene and/or C4 to C10 α-olefins, to produce the propylene copolymer such that the copolymer imbeds itself in the homopolymer as discrete domains with the homopolymer as a matrix or “continuous” phase. The MFR of the individual components can be controlled by, for example, the addition and/or removal of hydrogen from the reactors. Most preferably, the homopolymer can be produced in two loop-slurry reactors in series and each as a similar or same amount of hydrogen, producing homopolymer of nearly the same or the same MFR. The amount of hydrogen in the gas phase reactor can be the same or different from the loop slurry reactor, such level controlled by removing the hydrogen from the homopolymer stream entering the gas phase reactor or at some other stage. A suitable process and apparatus can be described in U.S. Pat. Nos. 9,000,106 and 8,076,419 (column 6, line 6 to column 7, line 16). The systems and processes disclosed therein can be used in a “balanced” reactor scheme where two slurry loop reactors in series forming the polypropylene homopolymer are under the same or similar conditions, followed by transfer of the crystalline polymer (polypropylene homopolymer) to a single gas phase reactor to form the semi-crystalline polymer (propylene copolymer).

When manufacturing either the homopolymer or copolymer, the properties of each can be tailored to meet certain desired needs to impart desirable final properties in the ICP described herein, and there can be a range of desirable properties that the ICP described herein can possess. For instance, the level of hydrogen in the reactor(s) can be adjusted, as can the polymerization temperature, residence time, identity of solvent (if any), as well as other factors.

Suitable ICPs include a polypropylene homopolymer and from 10, 15, 20, 22, or 24 wt % to 26, 28, 30, 35, 40, or 45 wt % of a propylene copolymer, based on the total weight of the ICP, wherein the copolymer comprises from about 7, or 10, or 15, or 20, or 25, or 30, or 35 wt % to 40 or 45, or 50, or 55 or 60 wt % ethylene, 1-butene, 1-hexene, and/or 1-octene derived units and from 80 to 40 wt % propylene-derived units based on the weight of the propylene copolymer. The propylene-based impact copolymer can have a MFR within a range of from 10, or 15, or 20, or 26 g/10 min to 30, or 36, or 40, or 50 g/10 min and an Elongation at Break of greater than 60, or 70, or 80, or 90, or 100% (or within a range from 60 or 80% to 120, or 150, or 300, or 400%). The MFR also can range from a low of about 2.5, 3.5 or 4 g/10 min to a high of about 10, 15, 20, or 30 g/10 min. Such an ICP tends to have an improved toughness (T-ICP) compared to other ICPs, described more herein. The propylene copolymer can be an ethylene-propylene copolymer.

Suitable ICPs also include a polypropylene homopolymer and from 6, or 8, or 10 wt % to 14, or 16, or 20 wt % of propylene copolymer based on the weight of the ICP, wherein the propylene copolymer comprises from 20, or 25, or 30, or 35 wt % to 40, or 45, or 50, or 55, or 60 wt % ethylene, 1-butene, 1-hexene and/or 1-octene derived units and from 80, 75, 70, or 65 wt % to 60, 55, 50, 45, or 40 wt % propylene-derived units based on the weight of the propylene copolymer. The ICP can have a MFR within a range of from 3, 5, 8, or 12 g/10 min to 20, 30, 40, or 50 g/10 min. Most preferably the propylene copolymer can be an ethylene-propylene copolymer.

Suitable ICPs have a molecular weight distribution (Mw/Mn) within a range from 4, or 5 to 7, or 8. In any embodiment, the size exclusion chromatograph (SEC) chromatogram can be unimodals, meaning there can be only one discernable SEC maximum, which can or cannot have a shoulder.

In an embodiment, the total comonomer derived unit content, preferably ethylene derived units of the ICP, can be within a range from 2 or 2.5 wt % to 4, or 6, or 10, or 16 wt % by weight of the ICP.

In an embodiment, the melting point temperature of the ICP can be greater than 155, or 160, or 162° C., or within a range from 155, or 160, or 162° C. to 170 or 180° C.

In an embodiment, the polypropylene homopolymer portion of the ICP has an Mw/Mn within a range of from 3.0, or 3.5, or 4.0 to 4.5, or 5.0, or 6.0, or 7.0, or 8.0, or 9.0; and the polypropylene homopolymer portion can also have an Mz/Mw of less than 4, or 3.4, or 3.2, or 3.0, or 2.8, or 2.6, or 2.4, or within a range from 2 to 2.5, or 2.6, or 2.8, or 3, or 3.2, or 3.4, or 4. By “polypropylene homopolymer” it is meant a polymer comprising within a range of from 0, or 0.01, or 0.1, or 0.5 to 2.0, or 3.0 wt %, by weight of the polymer, of ethylene, or C4 to C10 α-olefin-derived units, and most preferably refers to a polymer consisting of propylene-derived units.

In any embodiment the “propylene copolymer” or “copolymer” can be a polymer comprising ethylene, 1-butene, 1-hexene and/or 1-octene derived units, most preferably ethylene derived units.

In an embodiment the isopentad value for the polypropylene homopolymer can be greater than 92, or 94, or 96%, and less than or equal to about 99%.

In an embodiment, in particular for an ICP with high gloss, the MFR of the polypropylene homopolymer can be within a range from 5, or 10, or 15 g/10 min to 20, or 25, or 30, or 40 g/10 min. In embodiments for an impact copolymer with high toughness, the polypropylene homopolymer has a MFR within a range from 80 or 100 g/10 min to 120, or 140, or 160, or 180, or 200, or 220 g/10 min.

In an embodiment, the xylene cold soluble fraction of the ICP, which corresponds to the propylene copolymer portion of the ICP, has a number average molecular weight (Mn) within a range from 50,000 or 60,000 g/mole to 80,000 or 100,000 g/mole. In an embodiment, the propylene copolymer has a weight average molecular weight (Mw) within a range from 150,000, or 180,000, or 200,000 g/mole to 300,000, or 350,000, or 400,000 g/mole. And further, the propylene copolymer component can have a z-average molecular weight (Mz) within a range from 400,000, or 450,000, or 500,000, or 550,000 g/mole to 650,000, or 700,000, or 800,000, or 900,000 g/mole. The propylene copolymer component can have an Mz/Mw of less than 3.0, or 2.8, or 2.6, or 2.4, or within a range from 2.0 to 2.5, or 2.6, or 2.8.

In an embodiment, the propylene copolymer portion of the ICP has an Mw/Mn within a range of from 3.0, or 3.5, or 4.0 to 4.5, or 5.0, or 6.0, or 7.0, or 8.0, or 9.0. The propylene copolymer component has an Mz/Mw of less than 4, or 3.4, or 3.2, or 3.0, or 2.8, or 2.6, or 2.4, or within a range from 2 to 2.5, or 2.6, or 2.8, or 3, or 3.2, or 3.4, or 4.

In an embodiment, the propylene copolymer portion of the ICP has a melt flow rate within a range from 0.1 or 0.2 g/10 min to 0.6, or 0.8, or 1, or 2 g/10 min.

Also, in an embodiment, the propylene copolymer has an intrinsic viscosity (IV) within a range from 2 or 2.2 dL/g to 4, or 4.4, or 5, or 6 dL/g.

The ICP can be heterogeneous, meaning that there are domains of copolymer within a continuous phase of polypropylene homopolymer. Advantageously, the copolymer domains are relatively small, and the two domains are more miscible than prior art ICP heterogeneous domains. Thus, in preferred embodiments of the disclosure the polypropylene homopolymer forms a continuous phase and the copolymer, preferably an ethylene-propylene copolymer, forms copolymer domains having an average size (diameter) of less than 10, or 8, or 5, or 4, or 2 or 1 μm, or within a range of from 0.40, or 0.45, or 0.50 μm to 0.80, or 0.85, or 0.90, or 1, or 2, or 4, or 5, or 8, or 10 μm. The surface of the solid material can have high gloss, and thus, the surface gloss can be greater than 80, or 85, or 90 (ASTM D523), or greater than 70, or 75, or 80, or 85 measured at any one of 20, 60, or 85 degrees.

Suitable ICPs can desirably be made in a reactor in granules without further processing if desired. Thus, the impact copolymer in a preferred embodiment comprises reactor grade granules having an average particle size within a range of from 1200, or 1300, or 1400, or 1500 μm to 2000, or 2400, or 2800 μm and produced at a rate greater than 30,000, or 35,000 or 40,000, or 45,000 lbs/hr (13,620 kg/hr or 15,890 kg/hr, or 18,160 kg/hr, or 20,430 kg/hr).

In an embodiment, the ICP has a Heat Deflection Temperature (HDT) within a range of from 70, or 75, or 80, or 85° C. to 95, or 100, or 115, or 125° C.; or greater than 80, or 84, or 86, or 80, or 92° C. at 66 psi (ASTM D648). In an embodiment, the ICP has a HDT within a range of from 100, or 110° C. to 130, or 135, or 140, or 150° C.; or greater than 100 or 110° C. at 66 psi (ASTM D648).

Also, in an embodiment the ICP has a flexural modulus (1% Secant, ASTM D790A) of greater than 200, or 220, or 250, or 300 kpsi, or within a range of from 120, or 130, or 140 kpsi to 200, or 225, or 250, or 300, or 400 kpsi. The tensile strength at yield (ASTM D638) of the ICP described herein can be preferably within a range of from 2500 or 2600 or 2800 psi to 3000, 3500, or 4500, or 5500 psi; or greater than 2800, or 2900, or 3000, or 3200 psi.

The ICP can have a notched Izod impact at 23° C. as measured by ASTM D256A of greater than 4, or 5, or 6, or 8 ft-lb/in (213 J/m, or 267 J/m, or 320 J/m, or 426 J/m) (or within a range from 4 or 5, or 6, or 8 ft-lb/in to 10, or 12, or 14 ft-lb/in; 213 or 426 J/m to 533, or 640, or 693 J/m). Also, the notched Izod impact at 23° C. as measured by ISO 180/A can be preferably greater than 8, or 10, or 12, or 14, or 20, or 30, or 40 kJ/m2 (or within a range of from 8 or 10 kJ/m2 to 16, or 20, or 30, or 40, or 50, or 60 kJ/m2).

In a class of embodiments, the ICP can include a polypropylene homopolymer and from about 10 to about 45 wt % of propylene copolymer based on the weight of the ICP, wherein the propylene copolymer comprises from about 7 to about 60 wt % ethylene and/or C4 to C10 α-olefin derived units and the remainder propylene-derived units based on the weight of the propylene copolymer, the ICP having an MFR (230° C./2.16 kg) within the range of from about 10 to about 50 g/10 min and an Elongation at Break of greater than 60%. In various embodiments, the ICP can further have one or more of the following properties:
(a) a density (as measured at room temperature based on ASTM D1505) of about 0.86 g/cm³, 0.88 g/cm³ or 0.90 g/cm³ to about 0.91 g/cm³, 0.92 g/cm³, or 0.95 g/cm³;
(b) a melt index @230° C./2.16 kg of about 2.5 g/10 min to about 6.0 g/10 min, or about 3.5 g/10 min to about 4.5 g/10 min, or about 4.0 g/10 min to about 5.5 g/10 min, as measured according to ASTM D1238;
(c) a total propylene-derived unit content of from about 88 to about 92 wt %, more preferably from about 90 to about 91 wt %, based on the weight of the ICP;
(d) a flexural modulus (1% Secant, as measured based on ASTM D790A) of within a range of from about 130 to about 200 kpsi, or from about 130 to about 160 kpsi, or from about 140 to about 150 kpsi;
(e) a tensile strength at yield (as measured based on ASTM D638) of from about 2500 to about 4500 psi, or from about 2600 psi to about 3500 psi, or from about 2800 psi to about 3000 psi
(f) a notched Izod impact at 23° C. (as measured based on ISO 180/A) of greater than about 20, or about 30, or about 40 kJ/m²; and
(g) a heat deflection temperature (HDT) at 66 psi (as measured based on ASTM D648) of from about 75° C. to about 115° C., or from about 80° C. to about 100° C., or from about 85° C. to about 95° C.

Tensile properties of the ICP are determined according to ASTM D638, including Young's modulus (also called modulus of elasticity), yield stress (also called tensile strength at yield), yield strain (also called elongation at yield), break stress (also called tensile strength at break), and break strain (also called elongation at break). The energy to yield can be defined as the area under the stress-strain curve from zero strain to the yield strain. The energy to break can be defined as the area under the stress-strain from zero strain to the break strain. Injection-molded tensile bars were of either ASTM D638 Type I or Type IV geometry, tested at a speed of 2 inch/min. Compression-molded tensile bars were of ASTM D412 Type C geometry, tested at a speed of 20 inch/min. For compression-molded specimens only: the yield stress and yield strain were determined as the 10% offset values as defined in ASTM D638. Break properties were reported only if a majority of test specimens broke before a strain of about 2000%, which can be the maximum strain possible on the load frame used for testing.

Flexure properties of the ICP are determined according to ASTM D790A, including the 1% secant modulus. Test specimen geometry can be as specified under “Molding Materials (Thermoplastics and Thermosets)”, and the support span can be 2 inches.

Heat deflection temperature of the ICP can be determined according to ASTM D648, at 66 psi, on injection-molded specimens.

Suitable ICPs are commercially available from ExxonMobil Chemical Company.

### Blend Compositions

The propylene-based elastomeric composition includes at least one propylene-based elastomer and at least one impact copolymer. The amount of the at least one propylene-based elastomer in the blend composition is about 25 wt % to about 60 wt %, or about 30 wt % to about 55 wt %, about 35 wt % to about 50 wt %, about 40 wt % to about 60 wt %, or about 45 wt % to about 55 wt %, based on the total weight of the blend composition. Alternatively, the amount of the at least one propylene-based elastomer in the blend composition is about 20 wt %, 25 wt %, 30 wt %, 35 wt %, 40 wt %, 45 wt %, 50 wt %, 55 wt %, 60 wt %, 65 wt %, 70 wt %, or 75 wt %, based on the total weight of the blend composition. Alternatively, the amount of the at least one propylene-based elastomer in the blend composition can be less than 60 wt %, 55 wt %, 50 wt %, 45 wt %, 40 wt %, 35 wt %, 30 wt %, or 25 wt %, based on the total weight of the blend composition.

The amount of the at least one impact copolymer in the blend composition is about 20 wt % to about 60 wt %, or about 25 wt % to about 55 wt %, about 25 wt % to about 50 wt %, or about 35 wt % to about 50 wt %, based on the total weight of the blend composition. Alternatively, the amount of the at least one impact copolymer in the blend composition can be at least 15 wt %, 20 wt %, 25 wt %, 30 wt %, 35 wt %, 40 wt %, 45 wt %, 50 wt %, or 55 wt %, based on the total weight of the blend composition. Alternatively, the amount of the at least one impact copolymer in the blend composition can be less than 60 wt %, 55 wt %, 50 wt %, 45 wt %, 40 wt %, 35 wt %, 30 wt %, 25 wt %, or 20 wt %, based on the total weight of the blend composition.

In one embodiment, the amount of the ICP in the PBE composition is from about 30 to about 60 wt %, for example, about 30 wt %, about 35 wt %, about 40 wt %, about 45 wt %, about 50 wt %, about 55 wt %, about 60 wt %, or the ICP amount can vary in the range of any combination of the values recited herein, based on total weight of the PBE composition.

In certain embodiments, the PBE component or the PBE blend composition can optionally include up to 15 wt %, up to 10 wt %, or up to 5 wt % of one or more polyethylenes. Suitable polyethylenes include one or more ethylene homopolymers, ethylene copolymers, and compositions thereof. Useful ethylene copolymers include one or more comonomers in addition to ethylene and can be a random copolymer, a statistical copolymer, a block copolymer, and/or compositions thereof. In certain embodiments, the elastomer composition contains no polyethylenes and no ethylene copolymers, or less than 5 wt %, 4 wt %, 3 wt %, 2 wt %, or 1 wt %, based on the total weight of the elastomer composition.

### Additives

The propylene-based elastomer, the ICP component, and/or or the blend composition can contain one or more additives, depending on the intended purpose(s). The desired additives can be incorporated into the propylene-based elastomer, the ICP component and/or the blend composition directly or as part of a masterbatch, i.e., an additive package containing several additives to be added at one time in predetermined proportions. The additive package or masterbatch can be added in any suitable amount to accomplish the desired result. Such additives also can be introduced into the PBE blend composition during extrusion.

Suitable additives include one or more reinforcing and non-reinforcing fillers, antioxidants, stabilizers, processing oils, compatibilizing agents, lubricants (e.g., oleamide), antiblocking agents, antistatic agents, waxes, coupling agents for the fillers and/or pigment, pigments, flame retardants, antioxidants, and other processing aids known to the art. In some embodiments, the additive(s) is up to about 65 wt %, or up to about 60 wt %, or up to about 55 wt %, or up to about 50 wt % of the roofing composition. In some embodiments, the additive(s) is at least 5 wt %, or at least 10 wt %, or at least 15 wt %, or at least 20 wt %, or at least 25 wt %, or at least 30 wt %, or at least 35 wt %, or at least 40 wt % of the roofing composition. The additives can also range from a low of about 1 wt %, 3 wt %, or 4 wt % to a high of about 5 wt %, 8 wt %, or 10 wt %.

In some embodiments, the PBE blend compositions can include one or more fillers and/or one or more coloring agents. Exemplary materials include inorganic fillers such as calcium carbonate, clays, silica, talc, titanium dioxide or carbon black. Any type of carbon black can be used, such as channel blacks, furnace blacks, thermal blacks, acetylene black, lamp black and the like.

In some embodiments, the PBE blend compositions includes one or more flame retardants, such as calcium carbonate, inorganic clays containing water of hydration such as aluminum trihydroxides (“ATH”) or magnesium hydroxide. In some embodiments, the PBE blend composition includes one or more UV stabilizers, such as titanium dioxide or Tinuvin™ XT-850. Still other additives can include one or more antioxidant and/or thermal stabilizers. In an exemplary embodiment, processing and/or field thermal stabilizers include IRGANOX™ B-225 and/or IRGANOX™ 1010 available from BASF.

When present, any one or more fillers can form up to 5 wt %, or up to 10 wt %, or up to 15 wt %, or up to 20 wt %, or up to 25 wt %, or up to 30 wt %, or up to 35 wt %, or up to 40 wt % of the total weight of the PBE composition. In some embodiments, the PBE composition has from 5 wt % to 40 wt %, or from 10 wt % to 35 wt %, or from 15 wt % to 30 wt % of the one or more fillers.

Preferably, the one or more additive(s) can be present in an amount of about 0.01 wt % to about 10 wt %, or about 0.1 wt % to about 8 wt %, or from 1 wt % to 3 wt %, based on a total weight of the PBE blend composition. In a preferred embodiment, the PBE blend composition has at least one of an anti-oxidant agent and an anti-aging agent, particularly in an amount of from about 0.5 to about 5 wt %, for example, about 0.5 wt %, 0.6 wt %, 0.7 wt %, 0.8 wt %, 0.9 wt %, 1.0 wt %, 1.2 wt %, 1.4 wt %. 1.6 wt %, 1.8 wt %, 2 wt %, 3 wt %, 4 wt % or 5 wt %, based on total weight of the blend composition. In another preferred embodiment, a blend composition includes at least one of an anti-oxidant agent, an anti-aging agent, and a flame retardant, particularly in an amount of from about 0.5 to about 5 wt %, for example, about 0.5 wt %, 0.6 wt %, 0.7 wt %, 0.8 wt %, 0.9 wt %, 1.0 wt %, 1.2 wt %, 1.4 wt %. 1.6 wt %, 1.8 wt %, 2 wt %, 3 wt %, 4 wt % or 5 wt %, based on total weight of the blend composition.

### Membranes

The PBE blend compositions described herein are particularly useful for roofing applications, such as for thermoplastic polyolefin roofing membranes. Membranes produced from the blend compositions can exhibit a beneficial combination of properties, and in particular exhibit excellent melt strength and strain hardening properties, along with stability at extreme temperatures, such as those from −40° C. to 40° C. and up to 100° C.

The roofing compositions described herein can be made either by pre-compounding or by in-situ compounding using polymer-manufacturing processes such as Banbury mixing or twin screw extrusion. The blend compositions can then be formed into roofing membranes using conventional sheet extrusion or sheet extrusion laminating techniques. The roofing membranes can be particularly useful in commercial roofing applications, such as on flat, low-sloped, or steep-sloped substrates. In one example, a roofing membrane can be made having a top layer or surface that is a white reflective layer laminated over a bottom layer or bottom surface that is not color pigmented or simply black.

The roofing membranes can be fixed over the base roofing by any means known in the art such as via adhesive material, ballasted material, spot bonding, or mechanical spot fastening. For example, the membranes can be installed using mechanical fasteners and plates placed along the edge sheet and fastened through the membrane and into the roof decking. Adjoining sheets of the flexible membranes are overlapped, covering the fasteners and plates, and preferably joined together, for example with a hot air weld. The membrane can also be fully adhered or self-adhered to an insulation or deck material using an adhesive. Insulation is typically secured to the deck with mechanical fasteners and the flexible membrane is adhered to the insulation.

The roofing membranes can be reinforced with any type of scrim including, but not limited to, polyester, fiberglass, fiberglass reinforced polyester, polypropylene, woven or non-woven fabrics (e.g., Nylon) or combinations thereof. Preferred scrims are fiberglass and/or polyester.

Useful roofing membranes can have a thickness of from 0.1 to 5 mm, or from 0.5 to 4 mm or from 0.5 mm to 2 mm, or from 0.9 to 1.5 mm. In some embodiments, a surface layer of the top and/or bottom of the membrane can be textured with various patterns. Texture increases the surface area of the membrane, reduces glare and makes the membrane surface less slippery.

Examples of texture designs include, but are not limited to, a polyhedron with a polygonal base and triangular faces meeting in a common vertex, such as a pyramidal base; a cone configuration having a circular or ellipsoidal configurations; and random pattern configurations.

In addition to roofing materials, the PBE blends are useful in a variety of damp proofing and waterproofing applications, including membranes, liners or sheets for building foundations, building basements, flooring, baths, showers, reservoirs, ornamental pools, ponds, plaza decks, parking decks, walkways, tunnels, earthen shelters, bridge abutments, retaining walls, landfills, underground storage or reservoirs, chemical canals and water canals.

The PBE blends are also useful in protective cover applications favoring a combination of outstanding flexibility, strong bonding strength with substrates, and good mechanical performance, which can be required for use as shelter from elements including wind, rain, and sunlight, etc. Conveniently, the films of the present invention also can be adapted to form tarpaulins for a wide variety of applications, such as, protective covers against weather damages for buildings, unenclosed road, rail goods carrying vehicles or wood piles, and brickwork and masonry. Such tarpaulins can be perforated, which are typically used for medium to large advertising, or for protection on scaffoldings, with the aim of the perforations (from 20% to 70%) to reduce wind vulnerability.

Waterproof membranes, liners, or sheets having a thickness of 0.9 to 1.5 mm made from the PBE blend compositions provided herein can have any one or more of the following properties:
a) Tensile Force (N/50 mm) MD and TD of at least 600, at least 625, or at least 650, as measured by GB/T328.9-2007;
b) Tensile Strength (MPa) MD and TD of at least 12, at least 14, or at least 18, as measured by GB/T328.9-2007;
c) Elongation @ break (%) MD and TD of at least 500, at least 550, or at least 600, as measured by GB/T328.9-2007;
d) Tear strength around nail (N) MD and TD of at least 400, at least 450, or at least 500, as measured by GB/T 328.18;
e) Puncture strength (N) of at least 180, at least 185, or at least 190, as measured by CJ/T 234-2006;
f) Tensile Strength Keep Ratio (TSKR), %, MD and TD of at least 90%, at least 95% or at least 98%, where the TSKR is calculated as TSKR=[Tensile Strength as measured by GB/T328.9-2007 for a sample prior to heat resistance test]/[Tensile Strength as measured by GB/T328.9-2007, after sample is tested for heat resistance via GB/T 328.11-2007, Method B];
g) Elongation Keep Ratio (EKR), %, MD and TD of at least 80%, at least 85%, or at least 90%, where the EKR is calculated as EKR=[Elogation @ break as measured by GB/T328.9-2007 for a sample prior to heat resistance test]/[Elongation @ break as measured by GB/T328.9-2007, after sample is tested for heat resistance via GB/T 328.11-2007, Method B];
h) Dimensional Stability, %, MD and TD of 1.2 or less, 1.1 or less or 1.0 or less, as measured by GB/T 23457-2017; and/or
i) Shore D Hardness of 35-50, 40-50 or 38-48, as measured by GB/T 2411.
   The test methods identified in a)-i) above are National Standards of the People's Republic of China, which are publicly available in Mandarin. Each method is cited by the underground membrane industry standard document, T/CBMF 43-2019. The material disclosed herein is notable for being able to achieve certain levels of performance per the T/CBMF 43-2019 standard, which is of particular value in the Chinese market. GB/T 328.9-2007 corresponds largely to ISO 1421, though there are exceptions for certain types of materials. GB/T 2411 is identical to ISO 868. The remaining standards GB/T 328.18, CJ/T 234-2006, GB/T 328.11-2007 and GB/T 23457-2017 do not call out an ISO counterpart.

### Method of Making

The PBE blend compositions can be compounded by any convenient method, such as dry blending of the olefin-based copolymer, and optionally the fillers, the cross-linking pack, and other additives, and subsequently melt-mixing at a temperature above the melting temperature of the thermoplastic component, either directly in an extruder used to make the finished article, or by pre-melt mixing in a separate extruder (for example, a Banbury mixer). Dry blends of the polymer components can also be directly injection molded without pre-melt mixture. Examples of machinery capable of generating the shear and mixing include extruders with kneaders or mixing elements with one or more mixing tips or flights, extruders with one or more screws, extruders of co- or counter-rotating type, Banbury mixer, Farrell Continuous mixer, and the Buss Kneader. The type and intensity of mixing, temperature, and residence time required can be achieved by the choice of one of the above machines in combination with the selection of kneading or mixing elements, screw design, and screw speed (<3000 rpm). Typically the temperature for melt-mixing is from 60° C. to 130° C., and the residence time is from 10 to 20 minutes.

The blend composition can contain one or more additives, which can be introduced into the blend composition at the same time as the individual polymer components or later in case of using an extruder or Buss kneader or only later in time. The additives can be added to the blend in pure form or in masterbatches. The process oil or plasticizer can be added in one addition or in multiple additions. Preferably, the plasticizers are added after sufficient molten-state mixing of the polymer component and the optional one or more second polymers. The blend can either be a physical blend or an in-reactor blend manufactured by in-reactor processes as known to those of ordinary skill in the art.

### ADDITIONAL EMBODIMENTS

Additional embodiments of the waterproof membrane provided herein further includes and one or more of the following embodiments 1 to 20:

Embodiment 1. A waterproof membrane, comprising 40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene and/or one or more C₄-C₁₂ α-olefins, based on a total weight of the propylene-based elastomer; and 40 wt % to 60 wt % of at least one impact copolymer, based on the total weight of the blend composition; wherein the membrane has a thickness of 0.9 mm to 1.5 mm, a Tensile Force (N/50 mm) MD and TD of at least 600, as measured by GB/T328.9-2007, and a Tensile Strength (MPa) MD and TD of at least 12, as measured by GB/T328.9-2007.

Embodiment 2. The waterproof membrane according to Embodiment 1, wherein the at least one impact copolymer comprises a propylene homopolymer blended with a propylene copolymer.

Embodiment 3. The waterproof membrane according to Embodiments 1 or 2, wherein the propylene-based elastomer has a triad tacticity greater than about 90%, as measured by 13C NMR.

Embodiment 4. The waterproof membrane according to any of Embodiments 1-3, wherein the propylene-based elastomer has a density of about 0.85 g/cm³ to about 0.88 g/cm³.

Embodiment 5. The waterproof membrane according to any of Embodiments 1-4, wherein the propylene-based elastomer has a melt flow rate @230° C./2.16 kg of about 2.5 g/10 min to about 5 g/10 min, as measured according to ASTM D1238.

Embodiment 6. The waterproof membrane according to any of Embodiments 1-5, wherein the at least one impact copolymer has a melt index @230° C./2.16 kg of about 3.5 g/10 min to about 4.5 g/10 min, as measured according to ASTM D1238.

Embodiment 7. The waterproof membrane according to any of Embodiments 1-6, wherein the at least one impact copolymer has a density of about 0.88 g/cm³ to about 0.95 g/cm³.

Embodiment 8. The waterproof membrane according to any of Embodiments 1-7, wherein the propylene-based elastomer comprises about 3 wt % to about 15 wt % units derived from ethylene, based on the total weight of the propylene-based elastomer.

Embodiment 9. The waterproof membrane according to any of Embodiments 1-8, wherein the propylene-based elastomer has a density of about 0.85 g/cm³ to about 0.88 g/cm³ and a melt flow rate @230° C./2.16 kg of about 2.5 g/10 min to about 3.5 g/10 min, as measured according to ASTM D1238, and the at least one impact copolymer has a density of about 0.88 g/cm³ to about 0.95 g/cm³ and a melt index @230° C./2.16 kg of about 3.5 g/10 min to about 5 g/10 min, as measured according to ASTM D1238.

Embodiment 10. The waterproof membrane according to any of Embodiments 1-9, further comprising 1 wt % to 5 wt % of a masterbatch comprising one or more anti-oxidants and one or more anti-agents.

Embodiment 11. The waterproof membrane according to any of Embodiments 1-10, wherein the masterbatch further comprises at least one fire retardant additive.

Embodiment 12. The waterproof membrane according to any of Embodiments 1-11, further comprising: an elongation @beak (%) MD and TD of at least 500 as measured by GB/T328.9-2007; tear strength around nail (N) MD and TD of at least 400 as measured by GB/T 328.18, and puncture strength (N) of at least 180 as measured by CJ/T 234-2006.

Embodiment 13. A waterproof membrane, comprising 40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene, based on a total weight of the propylene-based elastomer; and 40 wt % to 60 wt % of at least one impact copolymer, based on the total weight of the blend composition, the at least one impact copolymer comprising a propylene homopolymer blended with a propylene copolymer, wherein the at least one impact copolymer has a total propylene-derived unit content of from about 88 to about 92 wt %, based on the weight of the ICP; wherein the membrane has a thickness of 0.9 mm to 1.5 mm, a Tensile Force (N/50 mm) MD and TD of at least 600, as measured by GB/T328.9-2007, and a Tensile Strength (MPa) MD and TD of at least 12, as measured by GB/T328.9-2007.

Embodiment 14. The waterproof membrane according to Embodiment 13, further comprising an elongation @beak (%) MD and TD of at least 500 as measured by GB/T328.9-2007; tear strength around nail (N) MD and TD of at least 400 as measured by GB/T 328.18, and puncture strength (N) of at least 180 as measured by CJ/T 234-2006.

Embodiment 15. The waterproof membrane according to Embodiments 13 or 14, wherein the propylene-based elastomer has a density of about 0.85 g/cm³ to about 0.88 g/cm³ and a melt flow rate @230° C./2.16 kg of about 2.5 g/10 min to about 3.5 g/10 min, as measured according to ASTM D1238, and the at least one impact copolymer has a density of about 0.88 g/cm³ to about 0.95 g/cm³ and a melt index @230° C./2.16 kg of about 3.5 g/10 min to about 4.5 g/10 min, as measured according to ASTM D1238.

Embodiment 16. The waterproof membrane according to any of Embodiments 13 to 15, wherein the at least one impact copolymer comprises 8 wt % to 20 wt % of the propylene copolymer based on the weight of the impact copolymer, wherein the propylene copolymer comprises from 20 wt % to 60 wt % ethylene, 1-butene, 1-hexene and/or 1-octene derived units.

Embodiment 17. The waterproof membrane according to any of Embodiments 13 to 16, wherein the at least one impact copolymer has a melt flow rate @230° C./2.16 kg of from 2.5 to 10 g/10 min.

Embodiment 18. A waterproof membrane, comprising: 40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene, based on a total weight of the propylene-based elastomer; and 40 wt % to 60 wt % of at least one impact copolymer, based on the total weight of the blend composition, the at least one impact copolymer comprising a propylene homopolymer blended with a propylene copolymer, wherein the at least one impact copolymer has a total propylene-derived unit content of from about 88 to about 92 wt %, based on the weight of the ICP; and 1 wt % to 5 wt % of a masterbatch comprising one or more anti-oxidants and one or more anti-agents, wherein the membrane has a thickness of 0.9 mm to 1.5 mm, a Tensile Force (N/50 mm) MD and TD of at least 600, as measured by GB/T328.9-2007, a Tensile Strength (MPa) MD and TD of at least 12, as measured by GB/T328.9-2007, an elongation @beak (%) MD and TD of at least 500 as measured by GB/T328.9-2007, a tear strength around nail (N) MD and TD of at least 400 as measured by GB/T 328.18, and a puncture strength (N) of at least 180 as measured by CJ/T 234-2006.

Embodiment 19. The waterproof membrane according to Embodiment 18, wherein the propylene-based elastomer has a melt flow rate @230° C./2.16 kg of about 3 g/10 min to about 30 g/10 min, as measured according to ASTM D1238, and the at least one impact copolymer has a melt flow rate @230° C./2.16 kg of from 3 to 10 g/10 min.

Embodiment 20. The waterproof membrane according to Embodiments 18 or 19, wherein the masterbatch further comprises at least one fire retardant additive.

To provide a better understanding of the embodiments of the present invention, the following non-limiting examples of preferred or representative embodiments are given. In no way should the following examples be read to limit, or to define, the scope of the invention.

### EXAMPLES

This disclosure will be described in more detail herein below by reference to the following non-limiting examples. The examples are not to be construed to limit the scope of the invention.

Three different TPO blends were prepared (Samples 1-3). Each blend was made of a propylene-based elastomer, an impact copolymer and an additive package. In each sample, the propylene-based elastomer was Vistamaxx™ 6102 and the impact copolymer was pp 7032E3, both obtained from ExxonMobil Chemical Company. The additive package contained AO 1010, which is an antioxidant additive that was obtained from BASF; AO 168, which is another antioxidant additive that was obtained from BASF, and PS 802, which is an anti-aging additive that was obtained from BASF.

“Vistamaxx™ 6102” has 16 wt % ethylene-derived units and a density of 0.862 g/cc (ASTM D1505), a melt index (190° C.; 2.16 kg) of 1.4 g/10 min (ASTM D1238), a melt mass-flow rate (MFR) (230° C.; 2.16 kg) of 3 g/10 min (ASTM D1238), a Shore A durometer hardness of 66 (ASTM D224), and a Vicat softening temperature of 52.2° C. (ASTM D1525).

“pp 7032E3” has a density of 0.90 g/cc (ASTM D1505), a melt mass-flow rate (MFR) (230° C.; 2.16 kg) of 4.0 g/10 min (ASTM D1238), a Rockwell hardness of 87 (ASTM D785), and a deflection temperature of 82.1° C. (ASTM D648, under load of 66 psi unannealed).

PP7032E3 was the major component in Sample #1. Vistamaxx™ 6102 was the major component in Sample #3. The blend formulations are reported below in Table 1. All numbers represent the weight percentage of each component in the blends.

TABLE 1
TPO underground solution formulations

| | | |
|---|---|---|
| Sample 1 | Sample 2 | Sample 3 |

| | | | | | | |
|---|---|---|---|---|---|---|
| Vistamaxx | 44.5 | wt % | 49.4 | wt % | 54.3 | wt % |
| 6102FL | | | | | | |
| PP7032E3 (ICP) | 54.3 | wt % | 49.4 | wt % | 44.5 | wt % |
| PS802 | 0.2 | wt % | 0.2 | wt % | 0.2 | wt % |
| AO1010 | 0.6 | wt % | 0.6 | wt % | 0.6 | wt % |
| AO168 | 0.4 | wt % | 0.4 | wt % | 0.4 | wt % |

Each Sample 1-3 blend was melted and extruded to form a sheet of about 1.2 mm in thickness and tested for flexibility, toughness and dimension stability characteristics, according to the T/CBMF 43-2019 standard test procedure, which is a Chinese standard for TPO waterproof applications. Table 2 below summarizes the test results.

TABLE 2
Strength results of TPO Samples 1-3.

| | | | | | | T/CBMF |
|---|---|---|---|---|---|---|
| | | | Sample 1 | Sample 2 | Sample 3 | 43-2019 |
| Tensile | Tensile Force | MD | 1115 | 1044 | 1183 | >=600 |
| | (N/50 mm) | TD | 1125 | 1139 | 1238 | >=600 |
| | Tensile | MD | 24.1 | 20.9 | 20.9 | >=12 |
| | Strength (MPa) | TD | 24.9 | 23.9 | 23.4 | >=12 |
| | Elongation | MD | 610 | 557 | 577 | >=500 |
| | @beak (%) | TD | 632 | 650 | 698 | >=500 |
| Tear strength | | MD | 620 | 612 | 552 | >=400 |
| around nail (N) | | TD | 689 | 619 | 559 | >=400 |
| Puncture strength (N) | | | 376 | 342 | 307 | >=180 |
| Anti-crack | | | Pass | Pass | Pass | Pass |
| Anti-loading | | | Pass | Pass | Pass | Pass |
| Heat Resistance | | | Pass | Pass | Pass | Pass |
| Low temperature bending | | | Pass | Pass | Pass | Pass |
| Heat | Tensile Strength | MD | 96 | 112 | 108 | >=90 |
| Aging | keep ratio, % | TD | 98 | 103 | 103 | >=90 |
| (80° C., | Elongation keep | MD | 90 | 103 | 101 | >=80 |
| 168 h) | ratio, % | TD | 95 | 97 | 96 | >=80 |

| | | | | |
|---|---|---|---|---|
| Low temperature | Pass | Pass | Pass | Pass |
| bending | | | | |

| | | | | | |
|---|---|---|---|---|---|
| Dimensional | MD | −0.2 | −0.3 | −0.7 | <=±1.2 |
| Stability, % | TD | −0.1 | −0.2 | −0.2 | <=±1.2 |

| | | | | |
|---|---|---|---|---|
| Shore D Hardness | 47 | 44 | 42 | 35~40 (with 3 |
| | | | | mm adhesive) |

The FIGURE graphically depicts the properties of Samples 1-3 reported in Table 2 in comparison to the minimum requirements of a waterproof composition as determined by the T/CBMF 43-2019 industry standard. The FIGURE shows that Samples 1-3 are not only suitable for use in waterproof applications, but Samples 1-3 also provided significant improvement in each property that was measured.

While compositions and methods are described herein in terms of “comprising” various components or steps, the compositions and methods can also “consist essentially of” or “consist of” the various components and steps. Additional embodiments provided herein include the following numbered embodiments:

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

All numerical values within the detailed description herein are modified by “about” the indicated value and take into account experimental error and variations that would be expected by a person having ordinary skill in the art”.

All documents described herein are incorporated by reference herein, including any priority documents and/or testing procedures. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

What is claimed is:

1. A waterproof membrane, comprising:
40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene and/or one or more C₄-C₁₂ α-olefins, based on a total weight of the propylene-based elastomer; and
40 wt % to 60 wt % of at least one impact copolymer, based on the total weight of the blend composition;
wherein the waterproof membrane has a thickness of 0.9 mm to 1.5 mm, a Tensile Force (N/50 mm) MD and TD of at least 600, as measured by GB/T328.9-2007, and a Tensile Strength (MPa) MD and TD of at least 12, as measured by GB/T328.9-2007.

2. The waterproof membrane of claim 1, wherein the at least one impact copolymer comprises a propylene homopolymer blended with a propylene copolymer.

3. The waterproof membrane of claim 1, wherein the propylene-based elastomer has a triad tacticity greater than about 90%, as measured by 13C NMR.

4. The waterproof membrane of claim 1, wherein the propylene-based elastomer has a density of about 0.85 g/cm³ to about 0.88 g/cm³.

5. The waterproof membrane of claim 1, wherein the propylene-based elastomer has a melt flow rate @230° C./2.16 kg of about 2.5 g/10 min to about 5 g/10 min, as measured according to ASTM D1238.

6. The waterproof membrane of claim 1, wherein the at least one impact copolymer has a melt index @230° C./2.16 kg of about 3.5 g/10 min to about 4.5 g/10 min, as measured according to ASTM D1238.

7. The waterproof membrane of claim 1, wherein the at least one impact copolymer has a density of about 0.88 g/cm³ to about 0.95 g/cm³.

8. The waterproof membrane of claim 1, wherein the propylene-based elastomer comprises about 3 wt % to about 15 wt % units derived from ethylene, based on the total weight of the propylene-based elastomer.

9. The waterproof membrane of claim 1, wherein the propylene-based elastomer has a density of about 0.85 g/cm³ to about 0.88 g/cm³ and a melt flow rate @230° C./2.16 kg of about 2.5 g/10 min to about 3.5 g/10 min, as measured according to ASTM D1238, and the at least one impact copolymer has a density of about 0.88 g/cm³ to about 0.95 g/cm³ and a melt index @230° C./2.16 kg of about 3.5 g/10 min to about 5 g/10 min, as measured according to ASTM D1238.

10. The waterproof membrane of claim 1, further comprising 1 wt % to 5 wt % of a masterbatch comprising one or more anti-oxidants and one or more anti-agents.

11. The waterproof membrane of claim 10, wherein the masterbatch further comprises at least one fire retardant additive.

12. The waterproof membrane of claim 1, further comprising:
an elongation @beak (%) MD and TD of at least 500 as measured by GB/T328.9-2007;
tear strength around nail (N) MD and TD of at least 400 as measured by GB/T 328.18, and
puncture strength (N) of at least 180 as measured by CJ/T 234-2006.

13. A waterproof membrane, comprising:
40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene, based on a total weight of the propylene-based elastomer; and
40 wt % to 60 wt % of at least one impact copolymer, based on the total weight of the blend composition, the at least one impact copolymer comprising a propylene homopolymer blended with a propylene copolymer, wherein the at least one impact copolymer has a total propylene-derived unit content of from about 88 to about 92 wt %, based on the weight of the ICP;
wherein the waterproof membrane has a thickness of 0.9 mm to 1.5 mm, a Tensile Force (N/50 mm) MD and TD of at least 600, as measured by GB/T328.9-2007, and a Tensile Strength (MPa) MD and TD of at least 12, as measured by GB/T328.9-2007.

14. The waterproof membrane of claim 13, further comprising:
an elongation @beak (%) MD and TD of at least 500 as measured by GB/T328.9-2007;
tear strength around nail (N) MD and TD of at least 400 as measured by GB/T 328.18, and
puncture strength (N) of at least 180 as measured by CJ/T 234-2006.

15. The waterproof membrane of claim 13, wherein the propylene-based elastomer has a density of about 0.85 g/cm³ to about 0.88 g/cm³ and a melt flow rate @230° C./2.16 kg of about 2.5 g/10 min to about 3.5 g/10 min, as measured according to ASTM D1238, and the at least one impact copolymer has a density of about 0.88 g/cm³ to about 0.95 g/cm³ and a melt index @230° C./2.16 kg of about 3.5 g/10 min to about 4.5 g/10 min, as measured according to ASTM D1238.

16. The waterproof membrane of claim 13, wherein the at least one impact copolymer comprises 8 wt % to 20 wt % of the propylene copolymer based on the weight of the impact copolymer, wherein the propylene copolymer comprises from 20 wt % to 60 wt % ethylene, 1-butene, 1-hexene and/or 1-octene derived units.

17. The waterproof membrane of claim 13, wherein the at least one impact copolymer has a melt flow rate @230° C./2.16 kg of from 2.5 to 10 g/10 min.

18. A waterproof membrane, comprising:
40 wt % to 60 wt % of at least one propylene-based elastomer, based on the total weight of the blend composition, the at least one propylene-based elastomer having a heat of fusion less than about 80 J/g as determined by DSC, a density of 0.850 g/cm³ to 0.920 g/cm³ per ASTM D-1505, crystallinity of 2% to 65% of isotactic polypropylene and a melting point (Tₘ) of 100° C. or less, wherein the propylene-based elastomer comprises greater than 50 wt % propylene and from about 3 wt % to about 25 wt % units derived from ethylene, based on a total weight of the propylene-based elastomer; and
40 wt % to 60 wt % of at least one impact copolymer, based on the total weight of the blend composition, the at least one impact copolymer comprising a propylene homopolymer blended with a propylene copolymer, wherein the at least one impact copolymer has a total propylene-derived unit content of from about 88 to about 92 wt %, based on the weight of the ICP; and
1 wt % to 5 wt % of a masterbatch comprising one or more anti-oxidants and one or more anti-agents,
wherein the waterproof membrane has a thickness of 0.9 mm to 1.5 mm, a Tensile Force (N/50 mm) MD and TD of at least 600, as measured by GB/T328.9-2007, a Tensile Strength (MPa) MD and TD of at least 12, as measured by GB/T328.9-2007, an elongation @beak (%) MD and TD of at least 500 as measured by GB/T328.9-2007, a tear strength around nail (N) MD and TD of at least 400 as measured by GB/T 328.18, and a puncture strength (N) of at least 180 as measured by CJ/T 234-2006.

19. The waterproof membrane of claim 18, wherein the propylene-based elastomer has a melt flow rate @230° C./2.16 kg of about 3 g/10 min to about 30 g/10 min, as measured according to ASTM D1238, and the at least one impact copolymer has a melt flow rate @230° C./2.16 kg of from 3 to 10 g/10 min.

20. The waterproof membrane of claim 18, wherein the masterbatch further comprises at least one fire retardant additive.
